(19) United States
(12) Patent Application Publication
(10) Pub. No.: US 2020/0001663 A1
(43) Pub. Date: Jan. 2, 2020

(54) PNEUMATIC TIRE

(71) Applicant: TOYO TIRE CORPORATION, Itami-shi (JP)

(72) Inventor: Tsuyoshi Fujioka, Itami-shi (JP)

(73) Assignee: TOYO TIRE CORPORATION, Itami-shi (JP)

(21) Appl. No.: 16/445,874

(22) Filed: Jun. 19, 2019

(30) Foreign Application Priority Data
Jun. 29, 2018 (JP) 2018-125004

(51) Int. Cl. B60C 13/02; B60C 11/01; B60C 13/00

(52) U.S. Cl. CPC B60C 13/02; B60C 2200/14; B60C 13/003; B60C 11/01

(57) ABSTRACT

A pneumatic tire includes a plurality of first protrusions provided at intervals in a tire circumferential direction, and a plurality of second protrusions provided adjacently so as to be alternately positioned with respect to the first protrusion in the tire circumferential direction. A length of each first protrusion in the tire circumferential direction is longer than a length of each second protrusion in the tire circumferential direction. The first protrusion has a first portion on both sides in the tire circumferential direction and the second protrusion has a second portion adjacent to the first portion in a tire radial direction, on both sides in the tire circumferential direction. The first protrusions face the respective second protrusions in the tire radial direction across a tire axis.

### CROSS-REFERENCE TO RELATED APPLICATIONS

This application claims priority of Japanese Patent Application No.: 2018-125004 filed on Jun. 29, 2018 the content of which is incorporated herein by reference.

### BACKGROUND OF THE INVENTION

### Technical Field

The present invention relates to a pneumatic tire.

### Related Art

Japanese Patent No. 6186334 discloses a pneumatic tire for improving the rigidity of a tire side portion. In this pneumatic tire, the tire side portion is provided with a plurality of protrusions adjacent in the tire circumferential direction.

### SUMMARY

In the pneumatic tire disclosed in Japanese Patent No. 6186334, a plurality of protrusions having the same length in the tire circumferential direction are only provided, and hence there is room for improvement in rigidity of the tire side portion in the tire circumferential direction and tire radial direction.

An object of the present invention is to provide a pneumatic tire in which the rigidity of the tire side portion in the tire circumferential direction and the tire radial direction is improved in a well-balanced manner.

One aspect of the present invention provides a pneumatic tire including: a plurality of first protrusions that protrude from a surface of a tire side portion and are provided at intervals in a tire circumferential direction; and a plurality of second protrusions that protrude from a surface of the tire side portion and are provided adjacently so as to be alternately positioned with respect to the first protrusions in the tire circumferential direction, wherein a length of each of the first protrusions in the tire circumferential direction is longer than a length of each of the second protrusions in the tire circumferential direction, each of the first protrusions has a first portion on both sides in the tire circumferential direction, each of the second protrusions has a second portion adjacent to the first portion in a tire radial direction on both sides in the tire circumferential direction, and each of the first protrusions and each of the second protrusions face each other in the tire radial direction across a tire axis.

The rigidity of the tire side portion in the tire circumferential direction and the tire radial direction becomes higher as the length of the protrusion in the tire circumferential direction becomes longer. Accordingly, in the tire side portion, the rigidity of a formation portion of the first protrusion is higher than the rigidity of a formation portion of the second protrusion. The first protrusions and the second protrusions which have the rigidity that is lower than that of the first protrusions face each other in the tire radial direction, instead of facing the highly rigid first protrusions to each other, and thus the rigidity balance when the tire rotates can be improved.

In the pneumatic tire according to the present invention, since the first protrusion and the second protrusion having different lengths in the tire circumferential direction are arranged to face each other in the tire radial direction, the rigidity of the tire side portion in the tire circumferential direction and the tire radial direction can be improved in a well-balanced manner and the tire design can be improved. Further, since the first protrusion and the second protrusion include the first portion and the second portion adjacent in the tire radial direction, an exposed area of the surface of the tire side portion can be reduced, and when the vehicle travels off-road, damage on the tire side portion due to a stone or the like can be suppressed.

### BRIEF DESCRIPTION OF THE DRAWINGS

The foregoing and the other features of the present invention will become apparent from the following description and drawings of an illustrative embodiment of the invention in which:

FIG. 1 is an axial side view of a tire according to an embodiment of the present invention;

FIG. 2 is a meridional sectional view of the tire of FIG. 1;

FIG. 3 is a partially enlarged view of FIG. 1;

FIG. 4 is a sectional view taken along a line IV-IV of FIG. 3; and

FIG. 5 is a sectional view taken along a line V-V of FIG. 3.

### DETAILED DESCRIPTION OF EMBODIMENTS

Hereinafter, an embodiment of the present invention will be described with reference to the drawings.

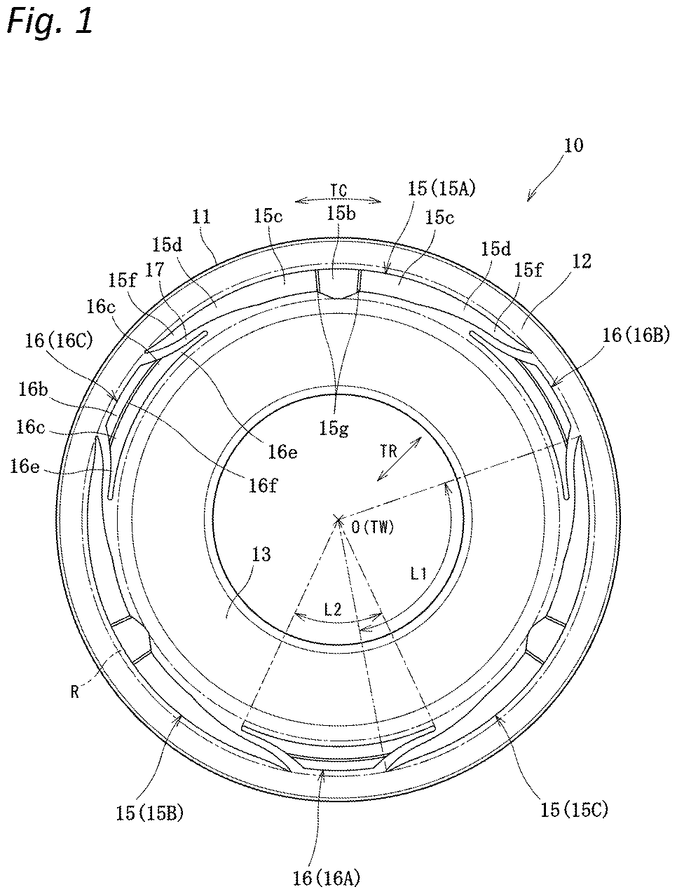

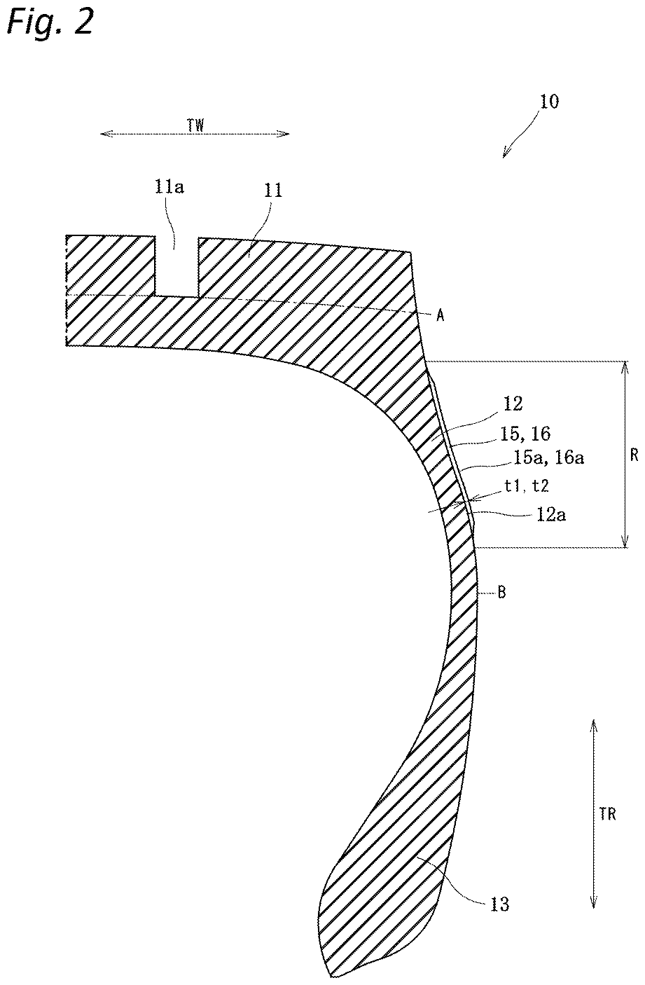

FIGS. 1 and 2 show a rubber pneumatic tire (hereinafter referred to as a tire) 10 according to the embodiment of the present invention. The tire 10 includes a tread portion 11, a pair of tire side portions 12, and a pair of bead portions 13.

The tread portion 11 has a groove 11a of a pattern shape predetermined on an outer surface side in a tire radial direction TR, and constitutes a tread surface to be grounded on the road surface. The tire side portion 12 is continuous to each of the both sides of the tread portion 11 in a tire width direction TW, and extends inside in the tire radial direction TR. The bead portion 13 is continuous to an inner side (opposite side of the tread portion 11) of the tire side portion 12 in the tire radial direction TR, and extends inside in the tire radial direction TR. An inner end of the bead portion 13 is assembled to a rim of a wheel (not shown). The pair of tire side portions 12 face in the tire width direction TW, and the pair of bead portions 13 face in the tire width direction TW.

When the vehicle travels on an unpaved off-road, the tire 10 may idle due to lack of traction and a surface 12a of the tire side portion 12 may be damaged by a sharp stone or the like. Therefore, in the present embodiment, in order to improve the rigidity and design of the tire side portion 12 while suppressing damage on the tire side portion 12, the tire side portion 12 is provided with two types of protrusions 15 and 16 having different lengths in a tire circumferential direction TC.

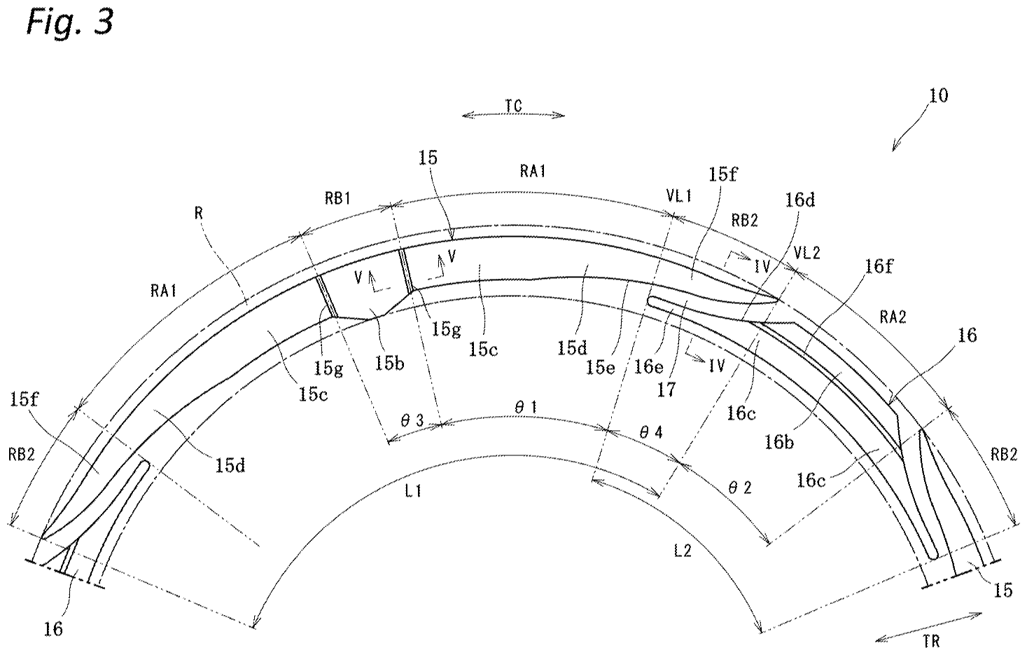

The protrusions 15 and 16 are formed in a predetermined protrusion formation region R indicated by two alternate long and short dash lines in FIGS. 1 and 3. Referring to FIG. 2, in the tire side portion 12, the protrusions 15 and 16 (protrusion formation region R) are formed between a groove bottom line A and a maximum width portion B. The groove bottom line A is a line (face) in the tire width direction TW that is substantially orthogonal to a center line (equator line) of the tread portion 11 in the tire width direction TW and passes through a bottom of the groove 11a formed on the tread portion 11. The maximum width portion B is the most protruding portion of the tire side portion 12 in the tire width direction TW.

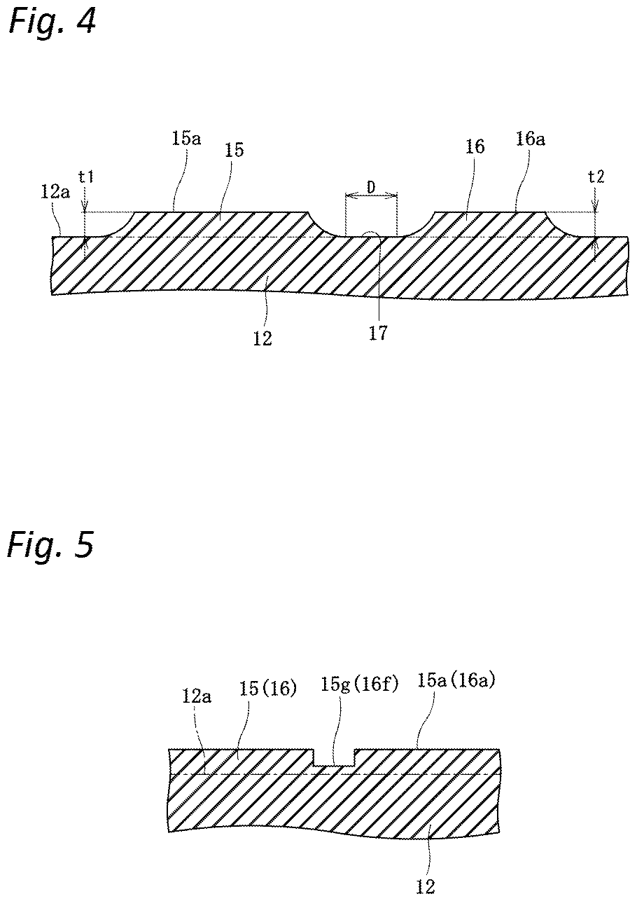

The protrusions 15 and 16 protrude outward in the tire width direction TW from the surface 12a of the tire side portion 12. Referring to FIG. 4, outer peripheral portions of the protrusions 15 and 16 are chamfered with a curvature in contact with the surface 12a of the tire side portion 12. A thickness t1 from the surface 12a of the tire side portion 12 to a surface 15a of the first protrusion 15 and a thickness t2 from the surface 12a of the tire side portion 12 to a surface 16a of the second protrusion 16 are identical. However, the thicknesses t1 and t2 of the first protrusion 15 and the second protrusion 16 may be different.

As shown in FIG. 1, the first protrusions 15 are provided at predetermined intervals in the tire circumferential direction TC. The second protrusions 16 are provided adjacent to the first protrusions 15 so as to be alternately positioned with respect to the first protrusions 15 in the tire circumferential direction TC. In the present embodiment, three of the first protrusions 15 and three of the second protrusions 16 are provided. The first protrusions 15 are arranged to face the respective second protrusions 16 in the tire radial direction TR across a tire axis O (three-equal disposition). The tire axis O is an axis that passes through the center of the tire side portion 12 and extends in the tire width direction TW.

Specifically, the first protrusion 15A faces, in the tire radial direction TR, the second protrusion 16A that is different from the adjacent second protrusions 16B and 16C. The first protrusion 15B faces, in the tire radial direction TR, the second protrusion 16B that is different from the adjacent second protrusions 16A and 16C. The first protrusion 15C faces, in the tire radial direction TR, the second protrusion 16C that is different from the adjacent second protrusions 16A and 16B. In sum, the first protrusion 15 and the second protrusion 16 that face each other form one set, and the plurality of sets of protrusions 15 and 16 are aligned in the tire circumferential direction TC.

Next, a specific configuration of the first protrusion 15 and the second protrusion 16 will be described.

As shown in FIGS. 1 and 3, the protrusions 15 and 16 are formed in the protrusion formation region R of the tire side portion 12 in order to improve the rigidity of the tire side portion 12. In the tire radial direction TR, the outermost end of the protrusions 15 and 16 is positioned on the outer peripheral portion of the protrusion formation region R, and the innermost end of the protrusions 15 and 16 is positioned on the inner peripheral portion of the protrusion formation region R. In other words, the outer diameter of the protrusion formation region R is positioned at the outermost end of the protrusions 15 and 16, and the inner diameter of the protrusion formation region R is positioned at the innermost end of the protrusions 15 and 16.

The protrusions 15 and 16 are formed such that lengths L1 and L2 in the tire circumferential direction TC are longer than a ground contact length of the tire 10. The first protrusion 15 includes a base portion 15b, a pair of arc portions 15c, and a pair of contraction portions 15d. The second protrusion 16 includes a base portion 16b and a pair of contraction portions 16c. In order to prevent reduction in the grounding property of the tread portion 11 due to excessive rigidity improvement, slits 15g and 16f are provided in the first protrusion 15 and the second protrusion 16. A relationship between the rigidity of the tire side portion 12 and the slits 15g and 16f will be described later in detail.

The base portion 15b of the first protrusion 15 is positioned at the center of the first protrusion 15 in the tire circumferential direction TC. The base portion 15b has a portion that protrudes in a shape of isosceles trapezoid inwardly in the tire radial direction TR. The width of the base portion 15b in the tire radial direction TR is larger than the widths of the other portions (the arc portion 15c and the contraction portion 15d). The inner end of the base portion 15b in the tire radial direction TR is the innermost end of the protrusions 15 and 16 and is positioned on the inner peripheral portion of the protrusion formation region R.

The arc portion 15c is continuous to each of the both ends of the base portion 15b, and extends outward in the tire circumferential direction TC. The width of the arc portion 15c in the tire radial direction TR is homogeneous, and the arc portion 15c is positioned at an interval with respect to the outer peripheral portion and the inner peripheral portion of the protrusion formation region R.

The contraction portion 15d is continuous to the outer end of the arc portion 15c in the tire circumferential direction TC, and extends outward in the tire circumferential direction TC. The width of the contraction portion 15d in the tire radial direction TR gradually narrows from the inside (the arc portion 15c) toward the outside of the tire circumferential direction TC. More specifically, an inner side 15e of the contraction portion 15d positioned inside the tire radial direction TR is curved in a shape of flow curve, and is overall inclined outward in the tire radial direction TR. The outer end of the contraction portion 15d in the tire circumferential direction TC is the outermost end of the protrusions 15 and 16 and is positioned on the outer peripheral portion of the protrusion formation region R.

The base portion 16b of the second protrusion 16 is positioned at the center of the second protrusion 16 in the tire circumferential direction TC. The width of the base portion 16b in the tire radial direction TR is homogeneous, and the base portion 16b is positioned at an interval with respect to the outer peripheral portion and the inner peripheral portion of the protrusion formation region R. More specifically, the width of the base portion 16b is narrower than the width of the base portion 15b of the first protrusion 15 and wider than the width of the arc portion 15c of the first protrusion 15.

The contraction portion 16c is continuous to both ends of the base portion 16b in the tire circumferential direction TC, and extends outward in the tire circumferential direction TC. The width of the contraction portion 16c in the tire radial direction TR gradually narrows toward the outer end from the inside (the base portion 16b) of the tire circumferential direction TC. More specifically, an outer side 16d of the contraction portion 16c positioned outside the tire radial direction TR is curved (inclined) inward the tire radial direction TR.

A part of the contraction portion 15d of the first protrusion 15 and a part of the contraction portion 16c of the second protrusion 16 are adjacent in the tire radial direction TR and overlap in the tire circumferential direction TC. Hereinafter, the part of the first protrusion 15 adjacent to the second protrusion 16 in the tire radial direction TR is referred to as a first adjacent portion (first portion) 15f, and the part of the second protrusion 16 adjacent to the first protrusion 15 in the tire radial direction TR is referred to as a second adjacent portion (second portion) 16e.

As most clearly shown in FIG. 3, the first adjacent portion 15f is a section positioned within a range from a virtual line VL1, which passes through the outer end of the contraction portion 16c (the second adjacent portion 16e) of the second protrusion 16 from the tire axis O (not shown in FIG. 3), to the outer end of the contraction portion 15d of the first protrusion 15. The second adjacent portion 16e is a section positioned within a range from a virtual line VL2, which passes through the outer end of the contraction portion 15d (the first adjacent portion 15f) of the first protrusion 15 from the tire axis O, to the outer end of the contraction portion 16c of the second protrusion 16. The first adjacent portion 15f is arranged outside in the tire radial direction TR with respect to the second adjacent portion 16e.

Referring to FIG. 4, the first adjacent portion 15f and the second adjacent portion 16e are arranged at a predetermined interval D. That is, a groove 17 having the predetermined interval D is formed between the first adjacent portion 15f and the second adjacent portion 16e. The bottom of the groove 17 is the surface 12a of the tire side portion 12. The width (the interval D) of the groove 17 is set in a range of 5 mm or more to 30 mm or less, and it is more preferably set in a range of 10 mm or more to 20 mm or less. If the groove 17 is set to a width narrower than 5 mm, the rigidity of the tire side portion 12 due to the protrusions 15 and 16 becomes excessive, and the grounding property of the tread portion 11 becomes worse. If the groove 17 is set to a width wider than 30 mm, the surface 12a of the tire side portion 12 exposed from between the adjacent portions 15f and 16e becomes likely to be damaged by a stone or the like. In order to minimize these problems, it is preferable to set the interval D between the first adjacent portion 15f and the second adjacent portion 16e within the above-described appropriate range.

In the tire radial direction TR, the total width of the first adjacent portion 15f and the second adjacent portion 16e put together is set to a range of 50 to 90% with respect to the width of the base portion 15b of the first protrusion 15 that is the widest part. In the tire circumferential direction TC, the distance from the outer end of the first adjacent portion 15f to the tip of the second adjacent portion 16e is set to a range of 40 to 70% with respect to the length L2 of the second protrusion 16. Damage on the tire side portion 12 due to a stone or the like is suppressed by forming the first adjacent portion 15f and the second adjacent portion 16e in these appropriate ranges.

As shown in FIGS. 1 and 3, the length L1 of the first protrusion 15 in the tire circumferential direction TC is longer than the length L2 of the second protrusion 16 in the tire circumferential direction TC. The length L1 of the first protrusion 15 is a distance in the tire circumferential direction TC from one of the outer ends of the pair of first adjacent portions 15f to the other. The length L2 of the second protrusion 16 is a distance in the tire circumferential direction TC from one of the outer ends of the pair of second adjacent portions 16e to the other.

The length L1 of the first protrusion 15 is set in a range of 20 to 40% of the tire circumferential length. The length L2 of the second protrusion 16 is assumed to be shorter than the length L1 of the first protrusion 15, and is set to a range of 10 to 20% of the tire circumferential length. The total protrusion area of the first protrusions 15 and the second protrusions 16 brought together is set so as to take up a range of 50 to 90% of the area of the protrusion formation region R.

The lengths L1 and L2 of the protrusions 15 and 16 formed in this manner are each longer than the ground contact length of the tire 10 in the tire circumferential direction TC. The ground contact length means the length in the tire circumferential direction TC and the tire width direction TW of the tread portion 11 that is actually in contact with the road surface when the vehicle travels. If the lengths L1 and L2 of the protrusions 15 and 16 are expressed in terms of angles, the angle range that forms the protrusions 15 and 16 is wider than the ground contact angle (more than approximately 30 degrees) corresponding to the ground contact length in the tire circumferential direction TC. Although the exact length of the tire ground contact length varies depending upon the tire diameter, the air pressure, and the vehicle weight, the exact angle of the tire ground contact angle is substantially the same.

Here, the rigidity of the tire side portion 12 varies depending upon the volume of the protrusions 15 and 16 to be formed, that is, the lengths L1 and L2 in the tire circumferential direction TC, the width in the tire radial direction TR, and the thicknesses t1 and t2 in the tire width direction TW, and the rigidity becomes higher as these get larger. As described above, the thicknesses t1 and t2 of the protrusions 15 and 16 of the present embodiment are identical, and the widths of the protrusions 15 and 16 are generally homogeneous overall. Accordingly, in the tire side portion 12, the rigidity of the formation portion of the first protrusion 15 is higher than the rigidity of the formation portion of the second protrusion 16. However, the second protrusion 16 in which the length L2 is formed in the above range is longer than the protrusion of the conventional tire (Japanese Patent No. 6186334). Therefore, in the tire 10 of the present embodiment, the rigidity in the tire circumferential direction TC of the tire side portion 12 and the tire radial direction TR can be effectively improved as compared with the conventional tire.

In the tire 10 of the present embodiment, the first protrusion 15 that is long in the tire circumferential direction TC and the second protrusion 16 that is short in tire circumferential direction TC are alternately arranged. Therefore, the rigidity of the tire side portion 12 in the tire circumferential direction TC and in the tire radial direction TR can be improved in a well-balanced manner, and the design of the tire 10 can also be improved.

Since the first protrusion 15 and the second protrusions 16 are arranged to face each other in the tire radial direction TR, the rigidity of the tire side portion 12 can be improved in a well-balanced manner also in this regard. Specifically, if the first protrusions 15 are caused to face each other and the second protrusions 16 are caused to face each other in the tire radial direction TR, the tire radial direction TR during traveling does not have a good rigidity balance because a high state and a low state are repeated. However, since in the present embodiment, the first protrusion 15 which is higher in rigidity and the second protrusion 16 which is lower in rigidity than the first protrusion 15 face each other, the rigidity in the tire radial direction TR is substantially homogeneous over the entire circumference. Therefore, the rigidity balance when the tire 10 rotates can be effectively improved.

The first protrusion 15 and the second protrusion 16 include the first adjacent portion 15f and the second adjacent portion 16e adjacent in the tire radial direction TR. In addition, the total protrusion area of the first protrusions 15 and the second protrusions 16 brought together is set in the range of 50 to 90% of the predetermined protrusion formation region R. Therefore, the exposed area of the surface 12a of the tire side portion 12 can be reduced. Therefore, when the vehicle travels off-road, damage on the surface 12a of the tire side portion 12 due to a stone or the like can be effectively suppressed.

Moreover, the adjacent portions 15f and 16e of the protrusions 15 and 16 are formed in a tapered shape, and the first adjacent portion 15f is arranged outside in the tire radial direction TR with respect to the second adjacent portion 16e. Therefore, the design of the tire side portion 12 can be effectively improved while the rigidity on the tread portion 11 side is effectively improved.

As described above, when the first protrusion 15 and the second protrusion 16, which are longer than the tire ground contact length, are provided in the tire side portion 12, the rigidity of the tire side portion 12 can be effectively improved. However, when the rigidity of the tire side portion 12 is excessively improved, the grounding property of the tread portion 11 with respect to the road surface may be deteriorated. Therefore, in the present embodiment, the slits 15g and 16f functionally divide the first protrusion 15 and the second protrusion 16, thereby ensuring the grounding property of the tread portion 11.

Referring to FIG. 5, the slit 15g of the first protrusion 15 and the slit 16f of the second protrusion 16 are constituted of grooves whose depth from the surfaces 15a and 16a to the bottom is shallower than the thicknesses t1 and t2 of the protrusions 15 and 16. For example, the thicknesses t1 and t2 of the protrusions 15 and 16 are 1.5 mm, and the depths of the slits 15g and 16f are 1.0 mm. The thickness of the tire side portion 12 in the tire width direction TW is about 10 mm, and the thicknesses t1 and t2 of the protrusions 15 and 16 are set to a range of 5 to 50% with respect to the thickness of the tire side portion 12, more preferably set to a range of 10 to 30%.

Referring to FIGS. 1 and 3, the slits 15g of the first protrusion 15 are respectively provided on the both sides of the base portion 15b in the tire circumferential direction TC, and divide the first protrusion 15 into three in the tire circumferential direction TC. The arc portion 15c is continuous to the base portion 15b via the slit 15g. The slit 15g extends linearly in the tire radial direction TR, and penetrates from the inner side to the outer side of the arc portion 15c.

The slit 16f of the second protrusion 16 is formed in an arc shape concentric with the tire side portion 12, and divides the second protrusion 16 into two in the tire radial direction TR. The slit 16f penetrates from one of the pair of outer sides 16d to the other so as to pass through the center of the second protrusion 16 in the tire radial direction TR.

As shown in FIG. 3, the protrusions 15 and 16, which include the slits 15g and 16f, can be divided into high rigidity regions RA1 and RA2 having a large protrusion area (areas of formation portions of the protrusions 15 and 16) and low rigidity regions RB1 and RB2 having a small protrusion area. The first high rigidity region (third region) RA1 is a portion of the first protrusion 15 formed between the base portion 15b and the first adjacent portion 15f, i.e., the arc portion 15c and the contraction portion 15d excluding the first adjacent portion 15f. The second high rigidity region (fourth region) RA2 is a portion of the second protrusion 16 formed between the pair of second adjacent portions 16e, i.e., the base portion 16b and the contraction portion 16c excluding the second adjacent portion 16e. The first low rigidity region (second region) RB1 is a portion of the first protrusion 15 formed between the two slits 15g, i.e., the base portion 15b. The second low rigidity region (first region) RB2 is a portion formed between the end portion of the first protrusion 15 (virtual line VL2) and the end portion of the second protrusion 16 (virtual line VL1), i.e., the adjacent portions 15f and 16e of the protrusions 15 and 16.

These are adjacent clockwise in order of the first high rigidity region RA1, the first low rigidity region RB1, the first high rigidity region RA1, the second low rigidity region RB2, the second high rigidity region RA2, and the second low rigidity region RB2. That is, the first high rigidity region RA1 is positioned between the first low rigidity region RB1 and the second low rigidity region RB2, and the second high rigidity region RA2 is positioned between the pair of second low rigidity regions RB2. One of the high rigidity regions RA1 and RA2 and one of the low rigidity regions RB1 and RB2 are alternately arranged.

The protrusion area of the first high rigidity region RA1 and the protrusion area of the second high rigidity region RA2 are identical within a predetermined first error range. The protrusion area of the first low rigidity region RB1 and the protrusion area of the second low rigidity region RB2 are identical within a predetermined second error range. The protrusion area of the high rigidity regions RA1 and RA2 is larger than the protrusion area of the low rigidity regions RB1 and RB2. For example, if the tire size is 11R24.5, the first error range is set to a range of 9,000 to 14,000 mm², and more preferably set to a range of 10,000 to 13,000 mm². The second error range is set to a range of 2,000 to 6,000 mm², and more preferably set to a range of 3,000 to 5,000 mm².

Angle ranges θ1 and θ2 of the high rigidity regions RA1 and RA2 centering on the tire axis O are smaller than a tire ground contact angle θ (which exceeds approximately 30 degrees) corresponding to the tire ground contact length. Angle ranges θ3 and θ4 of the low rigidity regions RB1 and RB2 centering on the tire axis O are smaller than the angle ranges θ1 and θ2 of the high rigidity regions RA1 and RA2. That is, the formation angle position of the slit 15g and the formation angle range of the adjacent portions 15f and 16e are formed such that the high rigidity regions RA1 and RA2 and the low rigidity regions RB1 and RB2 formed by these become smaller than the tire ground contact angle θ. In other words, the formation position of the slit 15g and the formation range of the adjacent portions 15f and 16e are set such that the length L1 of the first protrusion 15 in the tire circumferential direction TC becomes shorter than the ground contact length of the tire 10.

In the present embodiment, the angle range θ1 of the first high rigidity region RA1 is formed to be 30 degrees, and the protrusion area of the first high rigidity region RA1 is formed to be 12,000 mm². The angle range θ2 of the second high rigidity region RA2 is formed to be 22 degrees, and the protrusion area of the second high rigidity region RA2 is formed to be 11,000 mm². The angle range θ3 of the first low rigidity region RB1 is formed to be 10 degrees, and the protrusion area of the first low rigidity region RB1 is formed to be 4,300 mm². The angle range θ4 of the second low rigidity region RB2 is formed to be 14 degrees, and the protrusion area of the second low rigidity region RB2 is formed to be 4,000 mm².

In the tire 10 thus configured, the high rigidity portion that is longer than the tire ground contact length in the tire circumferential direction TC is eliminated, and hence the grounding property at the tread portion 11 of the tire 10 can be ensured. The high rigidity region RA1 or RA2 having a large protrusion area and the low rigidity region RB1 or RB2 having a small protrusion area are alternately arranged in the tire circumferential direction TC, and hence the high rigidity region RA1 or RA2 and the low rigidity region RB1 or RB2 are always positioned in the tire ground contact length. Therefore, the rigidity of the tire circumferential direction TC and the tire radial direction TR can be improved in a well-balanced manner while ensuring the grounding property of the tire 10.

As described above, in the tire 10 of the present embodiment, the protrusions 15 and 16 longer than the tire ground contact length in the tire circumferential direction TC are provided on the tire side portion 12, while the slits 15g and the adjacent portions 15f and 16e functionally divide the protrusions 15 and 16. Therefore, the rigidity and design of the entire tire 10 can be effectively improved, and the grounding property of the tire 10 can be ensured.

Note that the pneumatic tire 10 of the present invention is not limited to the configuration of the embodiment described above, and various modifications can be made.

For instance, the number of the first protrusions 15 and the second protrusions 16 may be four or more. The shape of the first adjacent portion (first portion) 15f and the second adjacent portion (second portion) 16e that are adjacent in the tire radial direction TR can be changed as needed. The first adjacent portion (first portion) may be arranged inside the second adjacent portion (second portion) 16e the tire radial direction TR. The lengths L1 and L2 of the protrusions 15 and 16 in the tire circumferential direction TC, the width in the tire radial direction TR, and the thicknesses t1 and t2 in the tire width direction TW can be changed as needed.

What is claimed is:

1. A pneumatic tire comprising:
a plurality of first protrusions that protrude from a surface of a tire side portion and are provided at intervals in a tire circumferential direction; and
a plurality of second protrusions that protrude from a surface of the tire side portion and are provided adjacently so as to be alternately positioned with respect to the first protrusions in the tire circumferential direction, wherein
a length of each of the first protrusions in the tire circumferential direction is longer than a length of each of the second protrusions in the tire circumferential direction,
each of the first protrusions has a first portion on both sides in the tire circumferential direction,
each of the second protrusions has a second portion adjacent to the first portion in a tire radial direction on both sides in a tire circumferential direction, and
each of the first protrusions and each of the second protrusions face each other in the tire radial direction across a tire axis.

2. The pneumatic tire according to claim 1, wherein
the first portion and the second portion gradually narrow in a width in the tire radial direction toward an end in the tire circumferential direction, and
the first portion is arranged outside in the tire radial direction with respect to the second portion.

3. The pneumatic tire according to claim 1, wherein
a length of the first protrusion in the tire circumferential direction is set to a range of 20 to 40% of a tire circumferential length, and
a length of the second protrusion in the tire circumferential direction is set to a range of 10 to 20% of the tire circumferential length.

4. The pneumatic tire according to claim 2, wherein
a length of the first protrusion in the tire circumferential direction is set to a range of 20 to 40% of a tire circumferential length, and
a length of the second protrusion in the tire circumferential direction is set to a range of 10 to 20% of the tire circumferential length.

5. The pneumatic tire according to claim 1, wherein
a length of an entire first protrusion in the tire circumferential direction is longer than a tire ground contact length in the tire circumferential direction, and
a slit that divides in the tire circumferential direction is formed in the first protrusion.

6. The pneumatic tire according to claim 2, wherein
a length of an entire first protrusion in the tire circumferential direction is longer than a tire ground contact length in a tire circumferential direction, and
a slit that divides in a tire circumferential direction is formed in the first protrusion.

7. The pneumatic tire according to claim 3, wherein
a length of an entire first protrusion in a tire circumferential direction is longer than a tire ground contact length in the tire circumferential direction, and
a slit that divides in the tire circumferential direction is formed in the first protrusion.

8. The pneumatic tire according to claim 4, wherein
a length of an entire first protrusion in the tire circumferential direction is longer than a tire ground contact length in the tire circumferential direction, and
a slit that divides in a tire circumferential direction is formed in the first protrusion.

9. The pneumatic tire according to claim 5, wherein a depth of the slit is shallower than a thickness of the first protrusion from a surface of the tire side portion to a surface of the first protrusion.

10. The pneumatic tire according to claim 5, wherein
the first protrusion is divided into three in the tire circumferential direction by two of the slits,
a protrusion area of a first region constituted of the first portion and the second portion and a protrusion area of a second region of the first protrusion positioned between the two slits are identical within a predetermined error range,
a protrusion area of a third region of the first protrusion positioned between the first region and the second region and a protrusion area of a fourth region of the second protrusion positioned between the first regions are identical within a predetermined error range,
a protrusion area of the first region and the second region is narrower than a protrusion area of the third region and the fourth region, and
any of the first region and the second region and any of the third region and the fourth region are alternately arranged in the tire circumferential direction.

11. The pneumatic tire according to claim 9, wherein
the first protrusion is divided into three in the tire circumferential direction by two of the slits,
a protrusion area of a first region constituted of the first portion and the second portion and a protrusion area of a second region of the first protrusion positioned between the two slits are identical within a predetermined error range,
a protrusion area of a third region of the first protrusion positioned between the first region and the second region and a protrusion area of a fourth region of the second protrusion positioned between the first regions are identical within a predetermined error range,
a protrusion area of the first region and the second region is narrower than a protrusion area of the third region and the fourth region, and
any of the first region and the second region and any of the third region and the fourth region are alternately arranged in a tire circumferential direction.

12. The pneumatic tire according to claim 1, wherein a total protrusion area of the first protrusion and the second protrusion brought together is set to a range of 50 to 90% of an area of a protrusion formation region between an outermost end and an innermost end of the first protrusion and the second protrusion in the tire radial direction.
